(19) United States
(12) Patent Application Publication
(10) Pub. No.: US 2002/0101805 A1
(43) Pub. Date: Aug. 1, 2002

(54) Optical disk recording device and recording method for the device

(76) Inventors: Hiromasa Ishiwata, Tokyo (JP); Seiichiro Miyaki, Tokyo (JP)

Correspondence Address: McGinn & Gibb, PLLC, Suite 200, 8321 Old Courthouse Road, Vienna, VA, 22182-3817, US

(21) Appl. No.: 10/055,187

(22) Filed: Jan. 25, 2002

(30) Foreign Application Priority Data
Jan. 29, 2001 (JP) 2001-020097

(51) Int. Cl. G11B 7/125

(52) U.S. Cl. 369/47.51

(57) ABSTRACT

An optical disk recording device is provided with an optical pickup. The optical pickup irradiates laser light onto an area for forming pits at a first output and irradiates laser light onto an area for forming no pits at a second output lower than the first output, during recording data in an optical disk. a first detector detects an intensity of reflected light of the laser light irradiated at the second output from an unrecorded area is detected. A second detector detects an intensity of reflected light of the laser light irradiated at the second output from a recorded area. A processor calculates a ratio of both intensities of the reflected light from the unrecorded area and the reflected light from the recorded area. A voltage adjuster adjusts the first output such that the intensity ratio is within a predetermined range.

### BACKGROUND OF THE INVENTION

1. Field of the Invention

The present invention relates to an optical disk recording device and a method for the device for use in recording data in once-writing compact disk (CD-R) and the like, particularly relates to the optical disk recording device and the method for the device intended to improve accuracy of adjustment of intensity of laser light.

2. Description of the Related Art

In the optical disk recording device, when data is recorded at a constant output of recording laser light, recording pits may not be formed in a predetermined shape due to fluctuation of temperature and recording sensitivity of the optical disk. When such recorded data is reproduced, symmetry or amplitude of waveform may often fluctuate, and error occurrence rate tends to increase. However, recording condition cannot be known until data is recorded and reproduced. Therefore, for example, Japanese Patent Laid-Open Publication No. Hei 7-235055 describes a method in which β value is obtained by reproducing data every time the data is written into a predetermined area in tracks, and CPU 110 corrects a setting data of laser power such that the β value shows a proper value, for example, 0. Herein, the β value was defined as following.

FIG. 1A to FIG. 1C are graphs showing relationship between the β value and alternating current (AC) component of reproduced RF signal. FIG. 1A shows the AC component in case that recording power P is smaller than optimum recording power P_{wo}. FIG. 1B shows the AC component in case that the recording power P is approximately equal to the optimum recording power P_{wo} FIG. 1C shows the AC component in case that the recording power P is larger than the optimum recording power P_{wo}. In these graphs, maximum portions indicate that signals are read from space areas where recording pits have not been formed, and minimum portions indicate that signals are read from areas where recording pits have been formed. Assuming that the largest maximum value is A1 and the smallest minimum value is A2, the β value is expressed in following formula 1.

β=((A1+A2)/(A1−A2))×100 (1)

As shown in FIG. 1B, when the recording power P is approximately equal to the optimum recording power P_{wo}, the recording pits are formed at proper depth, and absolute values of the maximum value A1 and the minimum value A2 coincide with each other. As a result, the β value becomes approximately 0. On the other hand, as shown in FIG. 1A, when the recording power P is smaller than the optimum power P_{wo}, the β value becomes negative, because the recording pits are formed shallower than a predetermined depth and intensity of light reflected from smaller recording pits increases. As shown in FIG. 1C, when the recording power P is larger than the optimum recording power P_{wo}, the β value becomes positive, because the recording pits are formed deeper than a predetermined depth and intensity of light reflected from smaller recording pits decreases.

However, correction of laser light output in this way requires repeat of recording and reproducing. Consequently, writing requires long time compared with the case of data recording only.

Therefore, a method, which controls the output of the laser light during recording, has been used, aiming to ensure better recording condition without reproducing. The method is known as a Running Optimum Power Control (ROPC).

A Differential Push Pull (DPP) method has been also used for tracking error correction in the optical disk recording device. FIG. 2 is a circuit diagram partly illustrating a photodetector and an RF amplifier in a conventional optical disk recording device.

In the optical disk recording device using the DPP method, laser light irradiated from a laser diode is split in a main beam for forming the recording pits in tracks, a front side beam irradiated ahead of the main beam in traveling direction relative to the optical disk, and a rear side beam irradiated behind of the main beam in traveling direction relative to the optical disk, and then the light beams are irradiated onto the optical disk. Then, returned light (reflected light) of each beam is detected by the photodetector 106 via a half mirror. The photodetector 106 is provided with a main detection section 106a for detecting the returned light of the main beam, a front sub detection section 106b for detecting the returned light of the front side beam, and a rear sub detection section 106c for detecting the returned light of the rear side beam. The main detection section 106a is defined into two areas parallel to the tracks, which are in turn defined into two areas perpendicular to the tracks, resulting in four areas a to d as a whole. The front sub detection section 106b is defined into two areas of e and f parallel to the tracks, and the rear sub detection section 106c is defined into two areas of g and h parallel to the tracks.

FIG. 3 is a schematic view illustrating a positional relationship between the main beam and the both side beams, and the tracks of the optical disk. In FIG. 3, recorded areas in which data has been recorded are hatched. Data is recorded in the optical disk 120 from inside track to outside track of the disk. The main beam is irradiated onto center of width of track 161 for writing data. In the track 161, an unrecorded area 164 exists behind the main beam in view from rotation direction of the optical disk 120, or ahead of relative traveling direction of the main beam, and a recorded area 165 exists ahead of the main beam in view from rotation direction of the optical disk 120, or behind the relative traveling direction of the main beam. Only a recorded area 165 exists in a track 162 inside of the track 161, and only an unrecorded area 164 exists in a track 163 outside of the track 161. The front side beam is irradiated to the center of width of band area between the tracks 161 and 163, while the rear side beam is irradiated to the center of width of band area between the tracks 161 and 162. Track pitch is about 1.6 μm, track width is about 0.7 μm, and diameter of each beam is 1 μm and over.

Sample and hold circuits (S/H's) 121 to 128 are interconnected within the RF amplifier 109, which are coupled to the areas a to h, respectively. A sampling pulse SP is input from a sampling pulse generator 108 into the S/H's 121 to 128. An operational amplifier 131 for adding respective output signals of the S/H 121 and the S/H 124, an operational amplifier 132 for adding respective output signals of the S/H 122 and the S/H 123, an operational amplifier 133 for adding respective output signals of the S/H 125 and the S/H 127, and an operational amplifier 134 for adding respective output signals of the S/H 126 and the S/H 128 are also provided. In addition, an operational amplifier 141 for operating differential between respective output signals of the operational amplifiers 131 and 132, and an operational amplifier 142 for operating differential between respective output signals of the operational amplifier 133 and 134 are provided. A multiplier 151, which multiplies an output signal of the operational amplifier 142 by K, is connected to an output terminal of the amplifier 142. An operational amplifier 152 for operating differential between respective output signals of the operational amplifier 141 and the multiplier 151. An output signal from the operational amplifier 152 becomes the tracking error signal DPP. The multiplier 151 is provided for compensating difference between gain in the operating amplifiers 131, 132, and 141, and gain in the operating amplifiers 133, 134 and 142, in case the gains are different each other, where the value of “K” is established according to the difference of the gains.

In such constructed conventional optical disk recording device, when irradiated position of the main beam is shifted from the center of the width of the track 161, the tracking error signal DPP is shifted from 0, and position of the optical pickup is adjusted according to a position correction signal from a central processing unit (not shown).

In the optical disk recording device using the aforementioned ROPC, intensity of the returned light of the main beam is detected during recording data, and output of the recording laser light is controlled according to the detection results. FIG. 4 is a timing chart showing fluctuation of level of the returned light of the main beam. The intensity of the returned light of the main beam is detected by sampling and holding signal from the main detection section 106a during laser is irradiated onto the optical disk at voltage applied for forming the recording pits in the tracks (recording power). In waveforms of the level of the returned light shown in FIG. 4, a solid line shows a case that laser is irradiated at optimum recording power, a broken line shows a case that laser is irradiated at larger recording power than the optimum value, and a dashed line shows a case that laser is irradiated at smaller recording power than the optimum value. Laser is irradiated onto areas for forming no recording pits, or areas for space at voltage applied for reproducing (reproducing power). The recording power is about 10 to 20 times of the reproducing power, which is constant.

At a predetermined timing during the laser light is output from the laser diode at the reproducing power, the sampling pulse is input into the S/H's 121 to 128, and output signal from the photodetector 106 is sampled and held. The operational amplifiers 131 to 134, 141, 142, and 152, as well as the multiplier 151 generate the tracking error signal DPP from signals held in the S/H's 121 to 128, and the position of the optional pickup is corrected according to the tracking error signal DPP.

Such ROPC is described in Japanese Patent Laid-Open Publication No. Hei 10-40548 and Japanese Patent No.3096239.

However, the conventional optical disk recording device using ROPC has a problem that noise of the returned light of the main beam and the fluctuation of level are large due to laser irradiation at the recording power, and thus output of the recording laser light can not be controlled sufficiently.

Further, the photodetector has an upper limit in its dynamic range. Therefore, when the returned light over the limit is input onto the photodetector, intensity of the light cannot be detected adequately.

### SUMMARY OF THE INVENTION

It is an object of the present invention to provide an optical disk recording device and a recording method for the device, which can adjust intensity of the laser light precisely during recording data.

An optical disk recording device according to the present invention comprises: an optical pickup which irradiates laser light onto an area for forming pits at a first output and irradiates laser light onto an area for forming no pits at a second output lower than the first output, during recording data in an optical disk; a first detector which detects an intensity of reflected light of the laser light irradiated at the second output from an unrecorded area; a second detector which detects an intensity of reflected light of the laser light irradiated at the second output from a recorded area; a processor which calculates a ratio of both intensities of the reflected light from the unrecorded area and the reflected light from the recorded area; and a voltage adjuster which adjusts the first output such that the intensity ratio is within a predetermined range.

In the present invention, the first output is adjusted according to the ratio of the intensity of the reflected light of the laser light irradiated at the second output from the recorded area to the intensity of the reflected light of the laser light irradiated at the second output from the unrecorded area. The intensity of the reflected light from the recorded area significantly depends on depth of the recording pits formed therein, therefore it can be known from the intensity whether the first output of the laser light was irradiated onto the area adequately or not. Further, external factors such as noise may hardly operate, because, the second output of the laser light irradiated onto the areas for forming no pits is typically constant, and the intensity of the reflected light of the laser light irradiated at the second output is lower than that at the first output. Consequently, optimum depth of the recording pits can be formed in the optical disk all the time, by adjusting the first output according to the intensity ratio of both reflected light beams, resulting in significant reduction of error occurrence rate during reproduction.

The optical pickup may comprise a laser diode and a beam splitter which splits laser light output from the laser diode to at least three laser lights and outputs the split laser lights onto a track for data recording and tracks outside and inside of the track for data recording. The first detector may detect reflected light from the track outside of the track for data recording, and the second detector may detect reflected light from the track inside of the track for data recording.

If a position adjuster is provided, which adjusts position of the optical pickup according to the intensities of the reflected light beams detected by the first and second detectors, tracking error correction of the laser light (main beam) irradiated onto the tracks for data recording and correction of the first output can be realized only by applying a slight correction to the conventionally used circuits.

A recording method for an optical disk recording device according to the present invention comprises the steps of: irradiating laser light from an optical pickup onto an area for forming pits at a first output, and irradiating laser light from the optical pickup onto an area for forming no pits at a second output lower than the first output, during recording data in the optical disk; detecting an intensity of reflected light of the laser light irradiated at the second output from an unrecorded area and an intensity of reflected light of the laser light irradiated at the second output from a recorded area; calculating a ratio of both intensities of the reflected light from the unrecorded area and the reflected light from the recorded area; and adjusting the first output such that the intensity ratio is within a predetermined range.

The irradiating laser light onto the optical disk may comprise the steps of splitting laser light output from a laser diode provided to the optical pickup to at least three laser lights and outputting the split laser lights onto a track for recording data and tracks outside and inside of the track for data recording. The detecting intensities of reflected light from the unrecorded and recorded areas may comprise the step of detecting reflected light from the track outside of the track for data recording and reflected light from the track inside of the track for data recording.

It is preferable that the recording method further comprises the step of adjusting position of the optical pickup according to the intensities of the reflected light from the unrecorded and recorded areas.

### BRIEF DESCRIPTION OF THE DRAWINGS

FIG. 1A to 1C are graphs illustrating a relationship between β value and AC component of a reproduced RF signal.

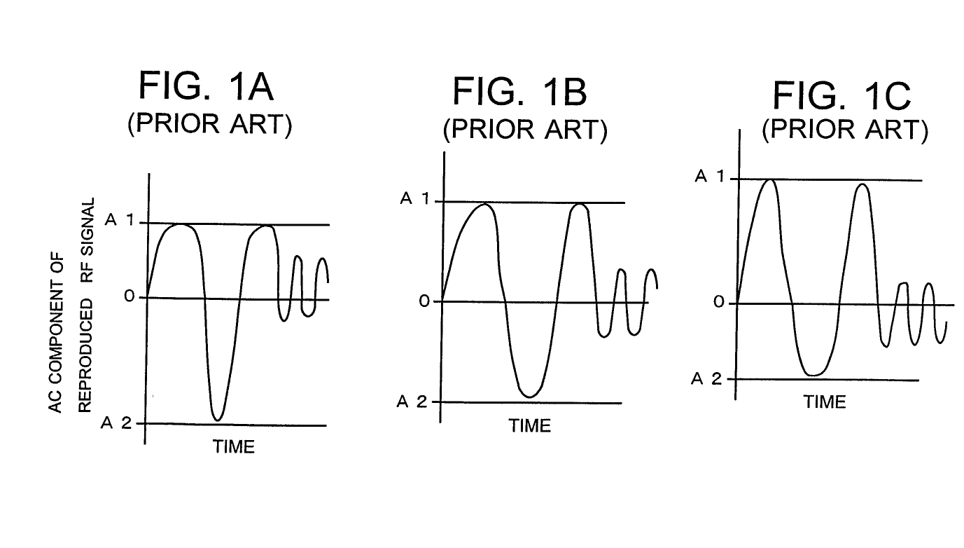

FIG. 2 is a circuit diagram partially illustrating a photodetector and an RF amplifier in a conventional optical disk recording device.

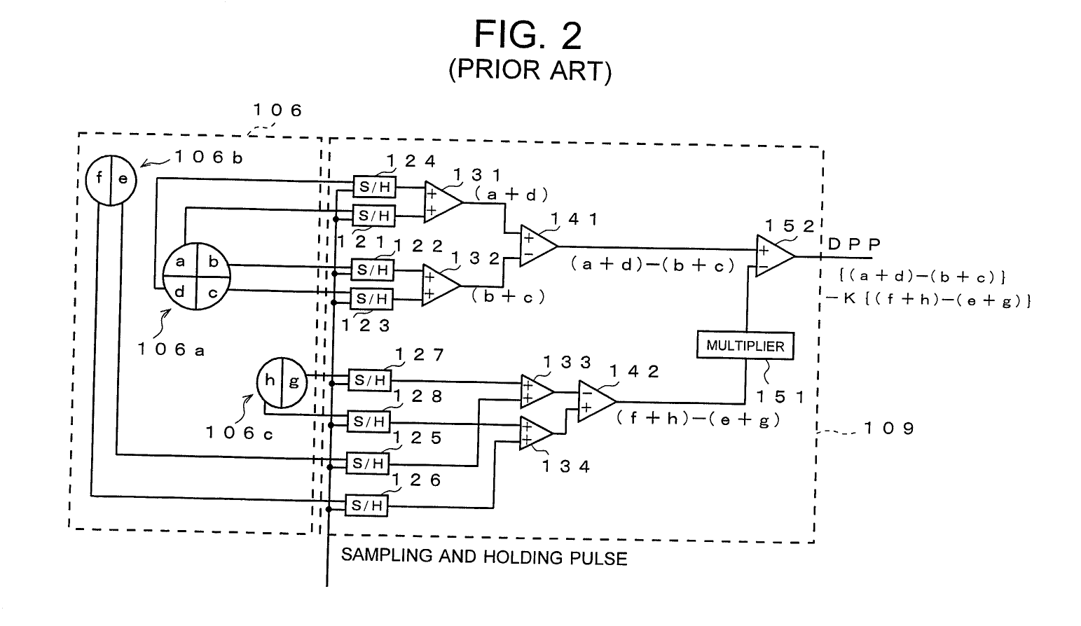

FIG. 3 is a schematic view illustrating a positional relationship between a main beam and both side beams, and tracks of the optical disk.

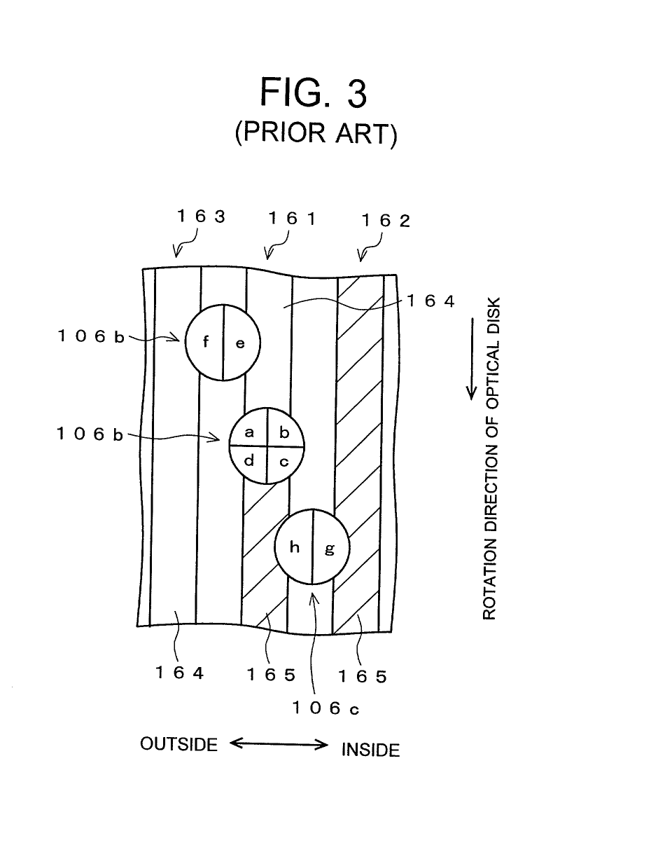

FIG. 4 is a timing chart illustrating fluctuation of level of returned light of the main beam.

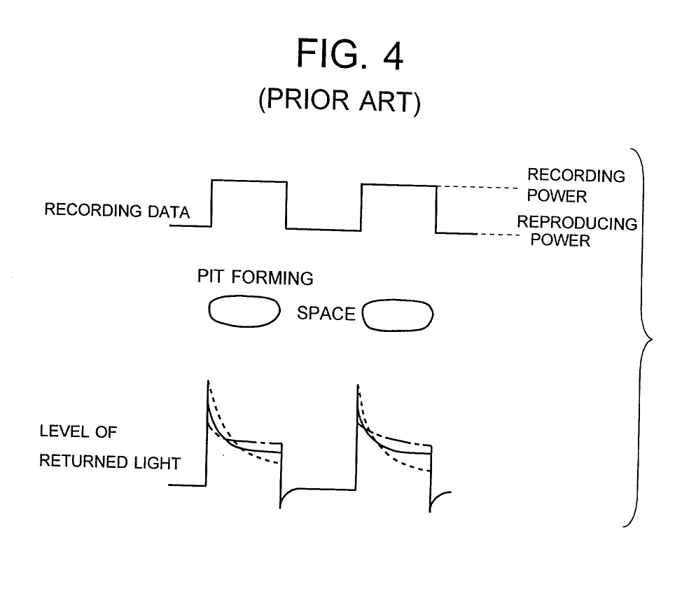

FIG. 5 is a block diagram illustrating a construction of an optical disk recording device according to an embodiment of the present invention.

FIG. 6 is a circuit diagram partially illustrating an optical pickup and a RF amplifier in the embodiment shown in FIG. 5.

FIG. 7 is a graph illustrating a relationship between the β value and F1/B1.

FIG. 8 is a flowchart illustrating an operation of the optical disk recording device according to the embodiment of the present invention.

FIG. 9 is a timing chart illustrating a relationship among an EFM data, a recording data, and a sampling pulse in an optical disk recording device according to the embodiment of the present invention.

### DETAILED DESCRIPTION OF THE PREFERRED EMBODIMENT

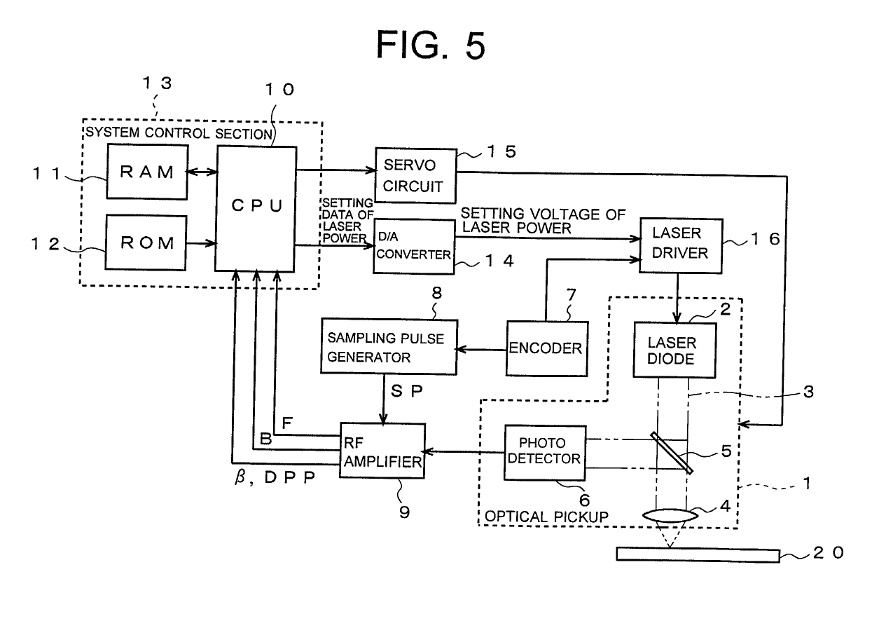

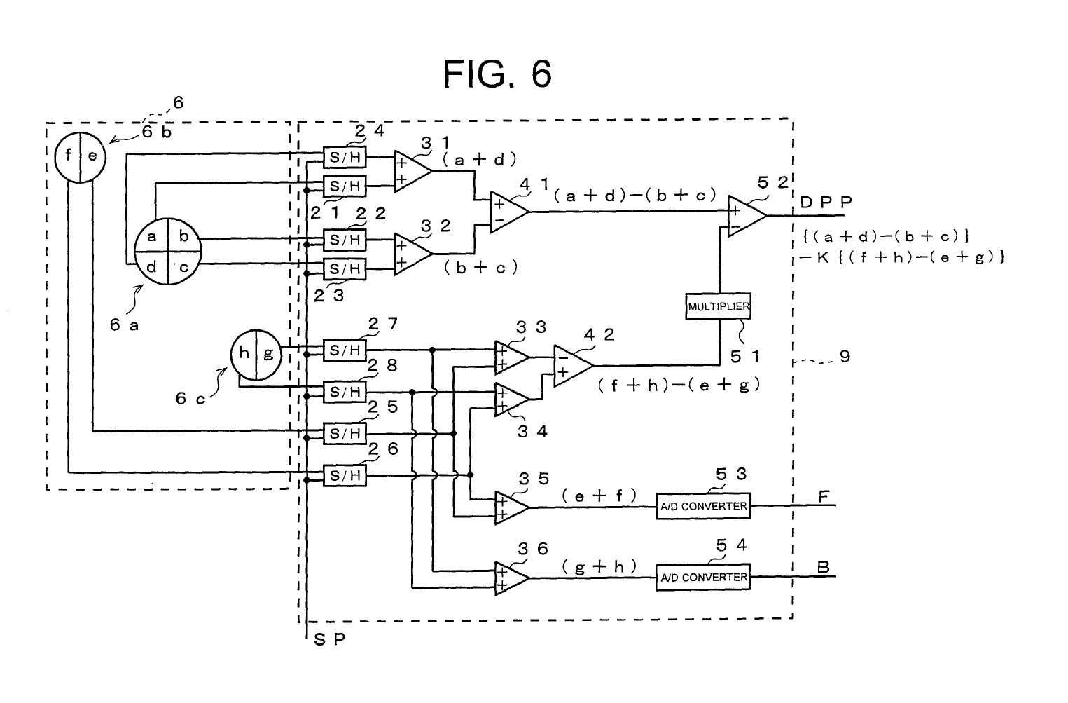

Hereinafter, preferred embodiments of the present invention will be described specifically with reference to the accompanying drawings. FIG. 5 is a block diagram illustrating the construction of an optical disk recording device according to an embodiment of the present invention, and FIG. 6 is a circuit diagram partially illustrating an optical pickup and an RF amplifier in the embodiment shown in FIG. 5.

An optical disk recording device according to the embodiment of the present invention is provided with an optical pickup 1. The optical pickup may be composed of a laser diode 2 for emitting laser light 3 to the optical disk 20, an objective lens 4 for focusing the laser light 3 on the surface of the optical disk 20, a half mirror 5 positioned between the laser diode 2 and the objective lens 4, and a photodetector 6 for sequentially converting the light reflected by the half mirror 5 to electric current and voltage, for example. In addition, an encoder 7 is provided to the optical disk recording device. The encoder 7 creates EFM (Eight to Fourteen Modulation) data from data for being recorded in the optical disk 20, and creates recording data from this EFM data according to a Write Strategy. Further, a sampling pulse generator 8 for outputting sampling pulse SP at a predetermined timing during the laser light is emitted at the reproducing power (the second output) according to the recording data, and an RF amplifier 9 for generating the tracking error signal DPP and the β value from output signal of the photodetector 6 are provided.

This embodiment is configured such that the RF amplifier 9 can also generate intensity signals F and B indicating the intensity of the returned light beams of front and rear side beams, respectively, as shown in FIG. 6. That is, the photodetector 6 is provided with a main detection section 6a for detecting the returned light of the main beam, a front sub detection section (the first detector) 6b for detecting the returned light of the front side beam, and a rear sub detection section (the second detector) 6c for detecting the returned light of the rear side beam. The main detection section 6a is defined into two areas parallel to the tracks, which are in turn defined into two areas perpendicular to the tracks, bringing in four areas a to d as a whole. The area a is positioned in front in relative traveling direction of the optical pickup 1 against the optical disk 20 and outside assuming that the optical disk 20 is normal, the area b is positioned in front in the traveling direction and inside, the area c is positioned in rear in the traveling direction and inside, and the area d is positioned in rear in the traveling direction and outside. The front sub detection section 6b is defined into two areas e and f parallel to the tracks, and the rear sub detection section 6c is defined into two areas g and h parallel to the tracks. The areas e and g are positioned inside, while the areas f and h are positioned outside, assuming that the optical disk 20 is normal.

In the RF amplifier 9, the areas a to h are connected to sample and hold circuits (S/H's) 21 to 28 respectively. A sampling pulse SP is input from the sampling pulse generator 8 to the S/H's 21 to 28. An operational amplifier 31 for adding output signals of the S/H's 21 and 24, an operational amplifier 32 for adding output signals of the S/H's 22 and 23, an operational amplifier 33 for adding output signals of the S/H's 25 and 27, an operational amplifier 34 for adding output signals of the S/H's 26 and 28, an operational amplifier 35 for adding output signals of the S/H's 25 and 26, and an operational amplifier 36 for adding output signals of the S/H's 27 and 28 are also provided. Further, an operational amplifier 41 for operating differential between output signals of the operational amplifiers 31 and 32, and an operational amplifier 42 for operating differential between output signals of the operational amplifiers 33 and 34 are provided. An output terminal of the operational amplifier 42 is connected to a multiplier 51 for multiplying an output signal of the operational amplifier 42 by K. In addition, an operational amplifier 52 for operating differential between output signals of the operational amplifier 41 and the multiplier 51 is provided. An output signal of the operational amplifier 52 becomes the tracking error signal DPP. The multiplier 51 is provided for compensating difference between gain by the operational amplifiers 31, 32 and 41 and gain by the operational amplifiers 33, 34 and 42, when the gains are different from each other, where the “K” value is established according to the difference of the gains.

Further, the RF amplifier 9 is provided with A/D converters 53 and 54 for converting output analogue signals of the operational amplifiers 35 and 36 to digital form respectively. Output signals of the A/D converters 53 and 54 become intensity signals F and B, respectively. The RF amplifier 9 is also provided with a circuit for obtaining the β value (not shown).

The optical disk recording device according to the present embodiment is provided with a system control section 13. the system control section 13 is provided with a central processing unit (CPU) (processor and voltage adjuster) 10, a random access memory (RAM) 11 for receiving/sending signals from/to this CPU 10, and a read-only memory (ROM) 12 which stores programs to be executed by the CPU 10 and the like. To the central processing unit 10, the intensity signals F and B output from the RF amplifier 9, the tracking error signal DPP, and the β value are input. The CPU 10 is connected to a D/A converter 14 to which a setting data of laser power determined by the CPU 10 according to the intensity signals F and B or the β value is input, and a servo circuit (position adjuster) 15 to which a position correction signal determined by the CPU 10 according to the tracking error signal DPP is input. The servo circuit 15 adjusts position of the optical pickup 1 mechanically such that the main beam is irradiated to a predetermined track according to the position correction signal. In addition, a laser driver 16 is provided, to which an analogue signal output from the D/A converter 14 is input as a setting voltage of the laser power. A recording data from the encoder 7 is also input to the laser driver 16, which supplies the setting voltage of the laser power to the laser diode 2 according to the recording data.

Next, an operation of the optical disk recording device constructed as above according to the present embodiment will be described. Hereinafter, intensity of the reflected light of the front side beam shown as the intensity signal F is referred as F1, while intensity of the reflected light of the rear side beam shown as the intensity signal B is referred as B1.

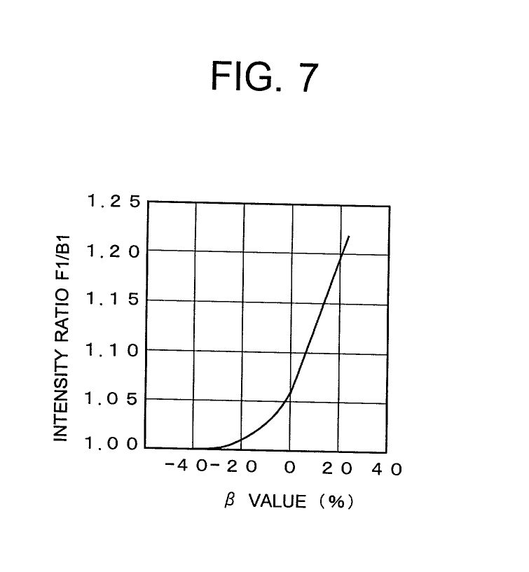

FIG. 7 is a graph illustrating a relationship between the β value and the F1/B1. The inventor noted that among the both side beams for use in the tracking error correction, the front side beam is irradiated only onto the “unrecorded area”, while the rear side beam is irradiated only onto the “recorded area”, and found that the β0 value correlates with the intensity ratio F1/B1 of the side beams. That is, the returned light (reflected light) of the front side beam has not been affected by diffraction caused by the recording pits, because the beam is irradiated to tracks under recording and “unrecorded area” of outside tracks of them. On the other hand, the returned light of the rear side beam has been affected by diffraction caused by the recording pits, because the beam is irradiated onto the tracks under recording and “recorded area” of inside tracks of them. The effect of the diffraction caused by the recording pits on the returned light of the rear side beam greatly concerns accuracy of formation of the recording pits or recording condition. For example, the diffraction operates slightly in case the recording power (the first output) is insufficient and the recording pits are formed shallowly, while the diffraction operates greatly in case the recording power is excessive and the recording pits are formed deep. Therefore, if correlation between the β value in the optical disk and the intensity ratio F1/B1 has been obtained before recording data, data recording can be achieved in optimum condition, by controlling the output of the laser light in order to obtain a particular intensity ratio F1/B1 such that the β0 value is within a predetermined range, for example within +5%, and is preferably 0%. For example, when the relationship as shown in FIG. 7 has been obtained previously, the output of the laser light is preferably controlled such that the intensity ratio F1/B1 always shows about 1.06.

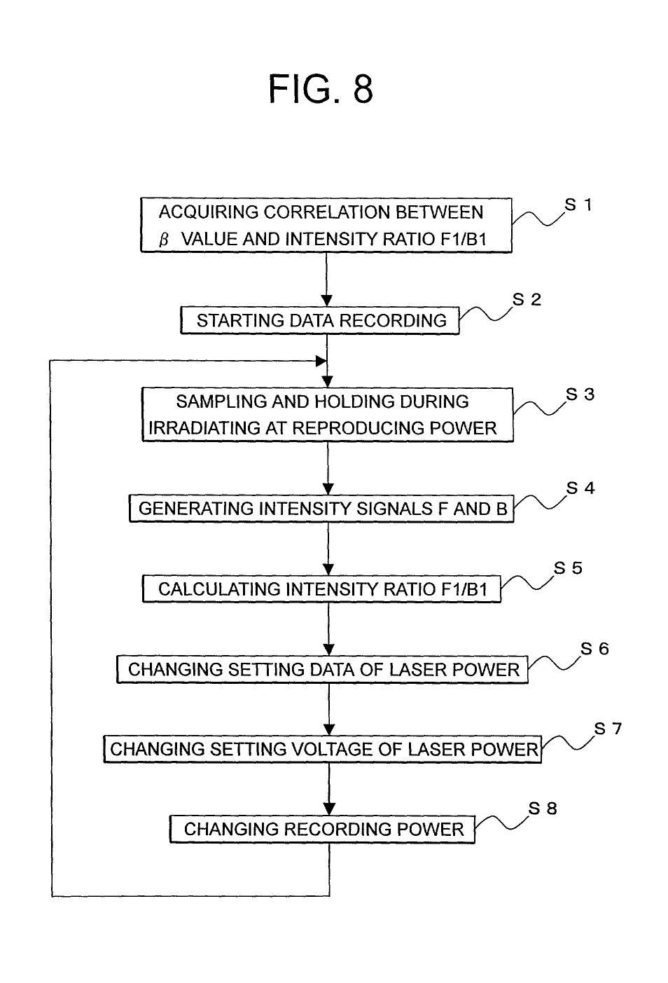

FIG. 8 is a flowchart illustrating an operation of the optical disk recording device according to the embodiment of the present invention. First, the relationship between the β value in the optical disk 20 for recording data and the intensity ratio F1/B1 is obtained (step S1), and stored in, for example, the RAM 11. The step may be performed by recording a predetermined data in Power Calibration Area (PCA) of the optical disk while detecting the intensity of the returned light of the front and rear side beams and reproducing the data to obtain the β value according to Optimum Power Control (OPC) of the recording laser light, for example. Alternatively, the relationship between the β value of the optical disk and the intensity ratio F1/B1 may have been obtained previously and stored in memory or others, because the relationship is almost constant among manufactures or kinds of media.

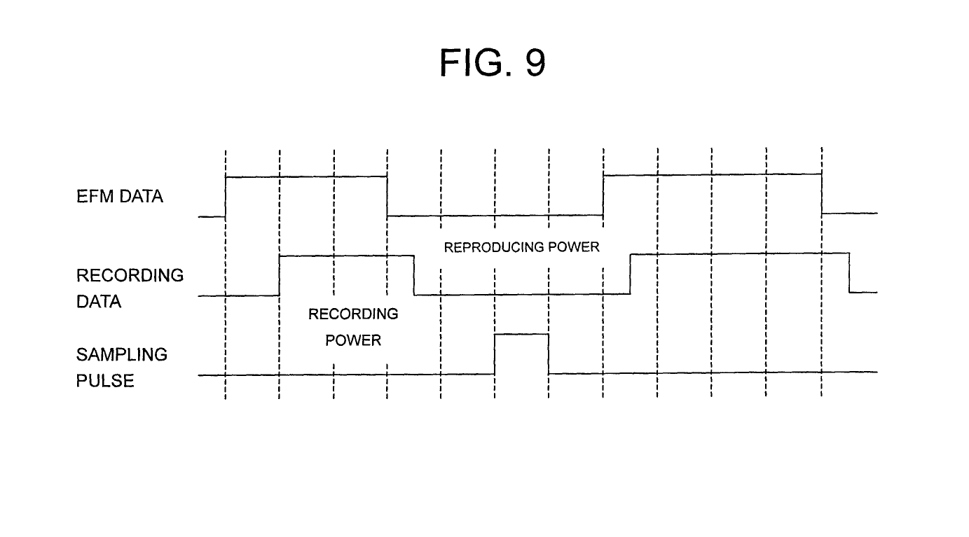

Next, data recording into the optical disk 20 begins (step S2). FIG. 9 is a timing chart illustrating a relationship among the EFM data, the recording data, and the sampling pulse in the optical disk recording device according to the present embodiment. In the present embodiment, the input data is coded into the EFM data as shown in FIG. 9 by the encoder 7, and then the recording data is created according to the Write Strategy. According to the setting voltage of the laser power, the laser driver 16 supplies the recording power to the laser diode 2 when the recording data is “high”, and supplies the reproducing power when the recording data is “low”.

The laser diode 2 emits the laser light 3 by the voltage supplied from the laser driver 16. The laser light 3 transmits through the half mirror 5 and is focused on the optical disk 20 through the objective lens 4. As a result, the recording pits are formed in the tracks when the recording data is “high”. The laser light 3 is split in the main beam, the front side beam, and the rear side beam through a beam splitter (not shown), and then the light beams are focused. Each reflected light (returned light) from the optical disk 20 is reflected by the half mirror 5 and then input into the photodetector 6. An intensity of the returned light of the main beam is detected by the main detector 6a, an intensity of the returned light of the front side beam is detected by the front sub detector 6b, and an intensity of the returned light of the rear side beam is detected by the rear sub detector 6c.

Then, the sampling pulse generator 8 outputs a sampling pulse SP into the RF amplifier 9 at a predetermined timing during the recording data from the encoder 7 is “low”, or during the laser light is output from the laser diode 2 at the reproducing power, as shown in FIG. 9. As a result, in the RF amplifier 9, the S/H's 21 to 28 samples and holds the output signals from the photodetector 6 (step S3).

The operational amplifiers 35 and 36, as well as A/D converters 53 and 54 generate intensity signals F and B from signals held in the S/H's 25-28 (step S4).

Thereafter, the intensity signals F and B are input into the CPU 10 which calculates the intensity ratio F1/B1 based on the intensity signals F and B by using the RAM 11, the ROM 12 and the like (step S5).

The CPU 10 further checks the obtained intensity ratio F1/F1 against the previously obtained relationship between the β value and the intensity ratio F1/F1, and changes the setting data of the laser power such that preferable β value, which ranges −5% to 5%, and is more preferably 0%, can be obtained (step S6).

After the setting data of the laser power is changed, the D/A converter 14 converts the changed data into an analogue signal, and outputs it into the laser driver 16 as the setting voltage of the laser power (step S7).

As a result, the recording power supplied from the laser driver 16 to the laser diode 2 is changed (step S8). Then, steps from sampling and holding the detection signal (step S3) to changing the recording power (step S8) are repeated until all data is recorded.

While the recording laser light is adjusted, the operational amplifiers 31 to 34, 41, 42 and 52, and multiplier 51 generate the tracking error signal DPP based on the signals held in the S/H's 21 to 28 during irradiation at the reproducing power. The CPU 10 outputs the position correction signal into the servo circuit 15 according to the tracking error signal DPP, and the servo circuit 15 corrects the position of the optical pickup 1.

According to the present embodiment, the recording power can be adjusted, consecutively detecting the returned light beams from the “unrecorded area” and the “recorded area” (ROPC). On this occasion, the returned light is detected for the front and rear side beams at the reproducing power, therefore factors other than the recording condition, including noise such as the returned light of the main beam irradiated at the recording power, hardly operate. Consequently, data can always be recorded in the optical disk 20 under optimum condition, even if temperature may fluctuate, because the recording condition can be detected more accurately.

In addition, cost rises slightly, because the S/H's 21 to 28 provided for the tracking error correction can be utilized and just a few circuits must be added as shown in FIG. 6.

Further, the light detected by the photodetector 6 may scarcely surpass the photodetector's dynamic range, because it is the returned light irradiated at the reproducing power of which intensity is low compared with the recording power.

While the above embodiment is of the optical disk recording device, it will be appreciated that this invention can be also used in the optical disk recording/reproducing device which combines reproducing function.

While the signal, indicating the intensity of the returned light irradiated at the reproducing power, is held by the S/H's 21 to 28 in the above embodiment, low-pass filters can be provided instead of the S/H's 21 to 28 as described in Japanese Patent Laid-Open Publication No. Hei 10-40548 and Japanese Patent No. 3096239.

What is claimed is:

1. An optical disk recording device comprising:
an optical pickup which irradiates laser light onto an area for forming pits at a first output and irradiates laser light onto an area for forming no pits at a second output lower than said first output, during recording data in an optical disk;
a first detector which detects an intensity of reflected light of said laser light irradiated at said second output from an unrecorded area;
a second detector which detects an intensity of reflected light of said laser light irradiated at said second output from a recorded area;
a processor which calculates a ratio of both intensities of said reflected light from said unrecorded area and said reflected light from said recorded area; and
a voltage adjuster which adjusts said first output such that said intensity ratio is within a predetermined range.

2. The optical disk recording device according to claim 1, wherein said optical pickup comprises a laser diode and a beam splitter which splits laser light output from said laser diode to at least three laser lights and outputs said split laser lights onto a track for data recording and tracks outside and inside of said track for data recording, said first detector detects reflected light from said track outside of said track for data recording, and said second detector detects reflected light from said track inside of said track for data recording.

3. The optical disk recording device according to claim 1, further comprising a position adjuster which adjusts position of said optical pickup according to the intensities of said reflected light detected by said first and second detectors.

4. The optical disk recording device according to claim 2, further comprising a position adjuster which adjusts position of said optical pickup according to the intensities of said reflected light detected by said first and second detectors.

5. A recording method for an optical disk recording device comprising the steps of:
irradiating laser light from an optical pickup onto an area for forming pits at a first output, and irradiating laser light from said optical pickup onto an area for forming no pits at a second output lower than said first output, during recording data in the optical disk;
detecting an intensity of reflected light of said laser light irradiated at said second output from an unrecorded area and an intensity of reflected light of said laser light irradiated at said second output from a recorded area;
calculating a ratio of both intensities of said reflected light from said unrecorded area and said reflected light from said recorded area; and
adjusting said first output such that said intensity ratio is within a predetermined range.

6. The recording method for an optical disk recording device according to claim 5, wherein said irradiating laser light onto said optical disk comprises the steps of splitting laser light output from a laser diode provided to said optical pickup to at least three laser lights and outputting said split laser lights onto a track for recording data and tracks outside and inside of said track for data recording, and said detecting intensities of reflected light from said unrecorded and recorded areas comprises the step of detecting reflected light from said track outside of said track for data recording and reflected light from said track inside of said track for data recording.

7. The recording method for the optical disk recording device according to claim 5, further comprising the step of adjusting position of said optical pickup according to the intensities of said reflected light from said unrecorded and recorded areas.

8. The recording method for the optical disk recording device according to claim 6, further comprising the step of adjusting position of said optical pickup according to the intensities of said reflected light from said unrecorded and recorded areas.
